(19) United States
(12) Patent Application Publication
(10) Pub. No.: US 2021/0394768 A1
(43) Pub. Date: Dec. 23, 2021

(54) DEVICE AND METHOD FOR CONTROLLING MOTION OF ELECTRIFIED VEHICLE

(71) Applicants: HYUNDAI MOTOR COMPANY, Seoul (KR); KIA MOTORS CORPORATION, Seoul (KR)

(72) Inventors: Seung Ki KIM, Suwon-si (KR); Sung Wook HWANG, Seoul (KR); Jae Il PARK, Seoul (KR)

(21) Appl. No.: 17/023,839

(22) Filed: Sep. 17, 2020

(30) Foreign Application Priority Data
Jun. 18, 2020 (KR) 10-2020-0074416

(51) Int. Cl. B60W 40/11; B60W 40/114; B60W 40/112

(52) U.S. Cl. CPC B60W 40/11; B60W 40/114; B60W 2520/105; B60W 2510/083; B60W 2520/28; B60W 40/112

(57) ABSTRACT

The present disclosure relates to a device and a method for controlling a motion of an electrified vehicle. The device includes a detector for detecting driving information of the vehicle, and a processor that estimates a roll angle and a pitch angle of the vehicle based on the driving information, determines whether the vehicle enters or exits a turning section based on the driving information, calculates a target pitch angle based on the estimated roll angle when the vehicle enters or exits the turning section, compares the target pitch angle with the estimated pitch angle, and controls a pitch motion of the vehicle based on the comparison result.

### CROSS-REFERENCE TO RELATED APPLICATION

This application claims the benefit of priority to Korean Patent Application No. 10-2020-0074416, filed in the Korean Intellectual Property Office on Jun. 18, 2020, the entire contents of which are incorporated herein by reference.

### TECHNICAL FIELD

The present disclosure relates to a device and a method for controlling a motion of an electrified vehicle.

### BACKGROUND

As interest in environmental issues increases, a development of an electrified vehicle using an electric motor in a driving scheme is accelerating. The electric motor mounted on such a vehicle is fast in control responsiveness and is able to accurately predict a motor torque. Wheels may be driven independently by installing each electric motor inside each wheel.

A technology for controlling a vehicle behavior (a vehicle motion) that affects vehicle riding comfort by utilizing the advantages of such an electric motor has been proposed. Among them, a scheme of controlling a pitch motion of the vehicle suppresses the pitch motion that unnecessarily occurs during travel to give an unpleasant feeling to a driver.

Such a pitch motion control scheme controls a longitudinal jerk to reduce a pitch angle of the vehicle when the vehicle is rapidly accelerated or decelerated. In addition, the pitch motion control scheme controls the longitudinal jerk to reduce a pitch angle that is generated when power is temporarily cut, such as gear shifting and the like.

As such, conventionally, the control is limited to the longitudinal movement of the vehicle, and it is insufficient to provide a satisfactory handling to the driver because a pitch angle generated during turning of the vehicle is not directly controlled. In other words, when the driver changes a travel direction of the vehicle by adjusting a steering wheel, the vehicle acts while sequentially generating a steering angle, a roll angle, and a pitch angle. In this connection, because the longer the delay between the roll angle and the pitch angle, the driver feels that the handling of the vehicle is bad.

### SUMMARY

The present disclosure has been made to solve the above-mentioned problems occurring in the prior art while advantages achieved by the prior art are maintained intact.

An aspect of the present disclosure provides a device and a method for controlling a motion of an electrified vehicle that control a pitch motion based on a longitudinal acceleration of the vehicle to reduce a difference between generation time points of a roll angle and a pitch angle generated in the vehicle when a driver steers.

The technical problems to be solved by the present inventive concept are not limited to the aforementioned problems, and any other technical problems not mentioned herein will be clearly understood from the following description by those skilled in the art to which the present disclosure pertains.

According to an aspect of the present disclosure, a device for controlling a motion of an electrified vehicle includes a detector for detecting driving information of the vehicle, and a processor that estimates a roll angle and a pitch angle of the vehicle based on the driving information, determines whether the vehicle enters or exits a turning section based on the driving information, calculates a target pitch angle based on the estimated roll angle when the vehicle enters or exits the turning section, compares the target pitch angle with the estimated pitch angle, and controls a pitch motion of the vehicle based on the comparison result.

In one implementation, the detector may include at least one of a wheel speed sensor, a steering torque sensor, a steering angle sensor, a yaw-rate sensor, a lateral acceleration sensor, or a longitudinal acceleration sensor.

In one implementation, the processor may compensate for an error caused by a road inclination and estimate the roll angle based on a wheel speed, a steering angle, a yaw-rate, and a lateral acceleration of the driving information.

In one implementation, the processor may compensate for an error caused by a road slope and estimate the pitch angle based on a wheel speed, a steering angle, a yaw-rate, and a longitudinal acceleration of the driving information.

In one implementation, the processor may recognize a steering intention of a driver based on a steering torque, a steering angle, a steering speed, a yaw-rate, and a lateral acceleration of the driving information.

In one implementation, the processor may determine that the vehicle enters the turning section, when an absolute value of the steering torque is equal to or higher than a reference torque, signs of the steering angle, the steering speed, and the steering torque are the same, and the yaw-rate and the lateral acceleration are respectively equal to or below a reference yaw-rate and a reference lateral acceleration.

In one implementation, the processor may determine that the vehicle exits the turning section, when an absolute value of the steering torque is equal to or higher than a reference torque, signs of the steering angle, the steering speed, and the steering torque are different from each other, the yaw-rate and the lateral acceleration are respectively equal to or above a reference yaw-rate and a reference lateral acceleration.

In one implementation, the processor may perform pitch angle generation control when the target pitch angle exceeds the estimated pitch angle when the vehicle enters the turning section.

In one implementation, the processor may perform pitch angle suppression control when the target pitch angle is less than the estimated pitch angle when the vehicle exits the turning section.

In one implementation, the processor may control the pitch angle and a yaw-rate simultaneously using a one-sided braking force when controlling the pitch motion of the vehicle is performed through deceleration control.

According to another aspect of the present disclosure, a method for controlling a motion of an electrified vehicle includes detecting driving information of the vehicle, estimating a roll angle and a pitch angle of the vehicle based on the driving information, determining whether the vehicle enters or exits a turning section based on the driving information, calculating a target pitch angle using the estimated roll angle when the vehicle enters or exits the turning section, comparing the target pitch angle with the estimated pitch angle, and controlling a pitch motion of the vehicle based on the comparison result.

In one implementation, the estimating of the roll angle and the pitch angle of the vehicle may include compensating for an error caused by a road inclination and estimating the roll angle based on a wheel speed, a steering angle, a yaw-rate, and a lateral acceleration of the driving information, and compensating for an error caused by a road slope and estimating the pitch angle by utilizing the wheel speed, the steering angle, the yaw-rate, and a longitudinal acceleration of the driving information.

In one implementation, the determining of whether the vehicle enters or exits the turning section may further include recognizing a steering intention of a driver based on a steering torque, a steering angle, a steering speed, a yaw-rate, and a lateral acceleration of the driving information.

In one implementation, the determining of whether the vehicle enters or exits the turning section may include determining that the vehicle enters the turning section, when an absolute value of the steering torque is equal to or higher than a reference torque, signs of the steering angle, the steering speed, and the steering torque are the same, and the yaw-rate and the lateral acceleration are respectively equal to or below a reference yaw-rate and a reference lateral acceleration, and determining that the vehicle exits the turning section, when the absolute value of the steering torque is equal to or higher than the reference torque, the signs of the steering angle, the steering speed, and the steering torque are different from each other, the yaw-rate and the lateral acceleration are respectively equal to or above the reference yaw-rate and the reference lateral acceleration.

In one implementation, the calculating of the target pitch angle may include calculating the target pitch angle minimizing a difference between generation time points of the roll angle and the pitch angle.

In one implementation, the controlling of the pitch motion may include performing pitch angle generation control when the target pitch angle exceeds the estimated pitch angle when the vehicle enters the turning section.

In one implementation, the controlling of the pitch motion may include performing pitch angle suppression control when the target pitch angle is less than the estimated pitch angle when the vehicle exits the turning section.

In one implementation, the controlling of the pitch motion may include calculating a longitudinal acceleration required for the vehicle for an actual pitch angle of the vehicle to follow the target pitch angle, and controlling acceleration or braking of the vehicle based on the calculated longitudinal acceleration.

In one implementation, the controlling of the pitch motion may include controlling the pitch angle and a yaw-rate simultaneously using a one-sided braking force when controlling the pitch motion of the vehicle is performed through deceleration control.

In one implementation, the controlling of the pitch motion further may include generating a motor traction force to offset a braking force remaining due to a response delay of a brake when deactivating braking control.

### BRIEF DESCRIPTION OF THE DRAWINGS

The above and other objects, features and advantages of the present disclosure will be more apparent from the following detailed description taken in conjunction with the accompanying drawings:

FIG. 1 is a block diagram for illustrating a motion control device of an electrified vehicle according to an embodiment of the present disclosure;

FIG. 2 is a flowchart for illustrating a motion control method of an electrified vehicle according to an embodiment of the present disclosure;

FIG. 3 is a view for illustrating motion control of an electrified vehicle according to another embodiment of the present disclosure;

FIGS. 4A and 4B are views for illustrating motion control of an electrified vehicle according to another embodiment of the present disclosure;

FIG. 5 is roll angle-pitch angle graphs with or without pitch motion control according to an embodiment of the present disclosure; and

FIGS. 6A to 6C are views for illustrating a change in a vehicle motion based on pitch motion control according to an embodiment of the present disclosure.

### DETAILED DESCRIPTION

Hereinafter, some embodiments of the present disclosure will be described in detail with reference to the exemplary drawings. In adding the reference numerals to the components of each drawing, it should be noted that the identical or equivalent component is designated by the identical numeral even when they are displayed on other drawings. Further, in describing the embodiment of the present disclosure, a detailed description of the related known configuration or function will be omitted when it is determined that it interferes with the understanding of the embodiment of the present disclosure.

In describing the components of the embodiment according to the present disclosure, terms such as first, second, A, B, (a), (b), and the like may be used. These terms are merely intended to distinguish the components from other components, and the terms do not limit the nature, order or sequence of the components. Unless otherwise defined, all terms including technical and scientific terms used herein have the same meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In the present specification, an electrified vehicle is a vehicle driven by an electric motor, which may include one of an electric vehicle (EV), a hybrid electric vehicle (HEV), a plug-in hybrid electric vehicle (PHEV), a fuel cell electric vehicle (FCEV), and the like.

In addition, in the present specification, a motion of rotating around an X-axis, which is a travel direction (a longitudinal direction) of the vehicle, will be referred to as a roll motion, a motion of rotating around a Y-axis, which is a width direction of the vehicle, will be referred to as a pitch motion, and a movement of rotating around a Z axis, which is a vertical direction from a vehicle's center of gravity (an origin point), will be referred to as a yaw motion.

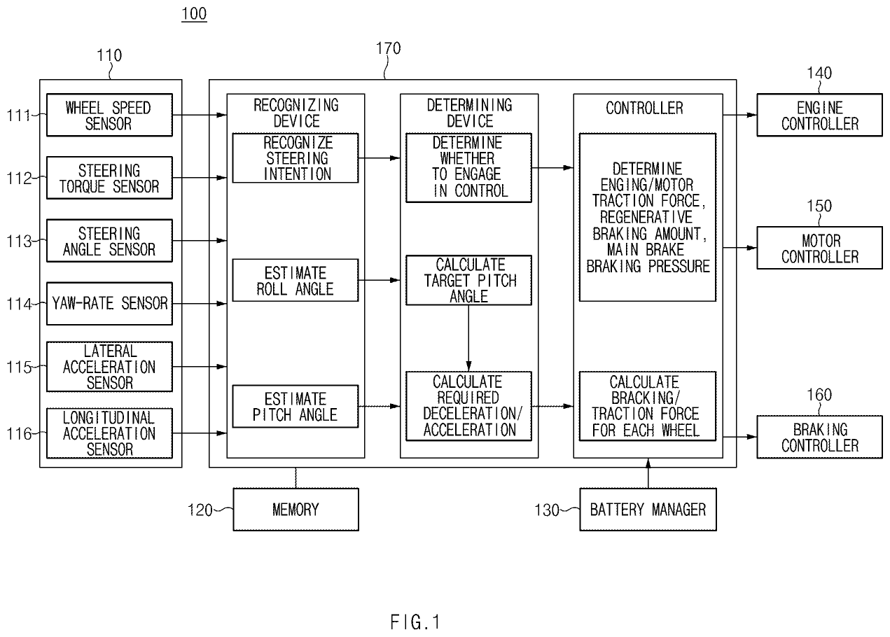

FIG. 1 is a block diagram for illustrating a motion control device of an electrified vehicle according to an embodiment of the present disclosure.

A motion control device 100 of the electrified vehicle includes a detector 110, a memory 120, a battery manager 130, an engine controller 140, a motor controller 150, a braking controller 160, and a processor 170.

The detector 110 may detect (acquire) driving information using sensors mounted on the vehicle. In this connection, the driving information may include a wheel speed, a steering torque, a steering angle, a yaw-rate, a lateral acceleration, and/or a longitudinal acceleration. The detector 110 may include a wheel speed sensor 111, a steering torque sensor 112, a steering angle sensor 113, a yaw-rate sensor 114, a lateral acceleration sensor 115, and/or a longitudinal acceleration sensor 116.

The wheel speed sensor 111 is mounted on a wheel to measure a wheel revolution per minute (a wheel speed). In the drawing, only one wheel speed sensor 111 is schematically illustrated, but the present disclosure is not limited thereto. Each wheel speed sensor 111 may be mounted for each wheel to measure a revolution per minute of each wheel.

The steering torque sensor 112 senses a torque that a driver applies to a steering wheel.

The steering angle sensor 113 measures a steering angle of the vehicle. The steering angle sensor 113 is installed on a steering column switch cluster to measure a rotation angle of the steering wheel.

The yaw-rate sensor 114 measures an angular speed of rotating around the Z axis, that is, a yaw-rate. As the yaw-rate sensor 114, a stability sensor, a gyro sensor, an inertial measurement unit (IMU), or the like may be used.

The lateral acceleration sensor 115 measures a lateral acceleration of the vehicle and the longitudinal acceleration sensor 116 measures a longitudinal acceleration of the vehicle. The lateral acceleration sensor 115 and the longitudinal acceleration sensor 116 may be implemented as three-axis accelerometers.

The memory 120 may be a non-transitory storage medium for storing instructions executed by the processor 170. The memory 120 may store input data and/or output data based on an operation of the processor 170. The memory 120 may store various setting information. The memory 120 may be implemented as at least one of storage media (recording media) such as a flash memory, a hard disk, a secure digital card (SD card), a random access memory (RAM), a static random access memory (SRAM), a read only memory (ROM), a programmable read only memory (PROM), an electrically erasable and programmable ROM (EEPROM), an erasable and programmable ROM (EPROM), a register, or the like.

The battery manager 130 serves to increase an energy efficiency and extend a battery life by optimally managing a vehicle battery (e.g., a high voltage battery). The battery manager 130 prevents overcharging or overdischarging by monitoring a voltage, a current, a temperature, and the like of the vehicle battery in real time. The battery manager 130 may calculate a remaining capacity, that is, a state of charge (SOC) of the vehicle battery.

The engine controller 140 controls an overall operation of an engine. The engine controller 140 may control a rotational speed and/or an output torque (an engine torque) of the engine in response to a command of the processor 170. The engine controller 140 may be implemented as an engine management system (EMS).

The motor controller 150 controls an output torque (a motor torque) of a driving motor (hereinafter, a motor) in response to a command of the processor 170. In other words, the motor controller 150 receives a target motor torque from the processor 170 as the command, and controls a rotational speed of the motor in response to the received command.

The braking controller 160 is for controlling a speed of the vehicle, which may be implemented as an electronic stability control (ESC). The braking controller 160 controls a braking pressure in response to a command of the processor 170.

Each of the battery manager 130, the engine controller 140, the motor controller 150, and the braking controller 160 may include at least one processor, a memory, and a network interface. The processor may be a semiconductor device (e.g., an integrated circuit) that executes processing for instructions stored in the memory.

The processor 170 controls an overall operation of the motion control device 100. The processor 170 may be implemented as at least one of an application specific integrated circuit (ASIC), a digital signal processor (DSP), a programmable logic device (PLD), a field programmable gate array (FPGA), a central processing unit (CPU), a microcontroller, or a microprocessor.

The processor 170 may recognize a steering intention of the driver by utilizing the driving information. The processor 170 may determine whether the driver has the steering intention using the steering torque, the steering angle, the steering speed, the yaw-rate, and/or the lateral acceleration. For example, when a change in the steering torque is sensed and a change in the steering angle is sensed, the processor 170 may determine that the driver has the steering intention. When there is no change in the steering torque but the change in the steering angle is sensed, the processor 170 may determine that the driver has no steering intention.

When an absolute value of the steering torque is equal to or higher than a reference torque, signs of the steering angle, the steering speed, and the steering torque are the same, and the yaw-rate and the lateral acceleration are respectively equal to or below a reference yaw-rate and a reference lateral acceleration, the processor 170 may determine that the driver has a turning control intention. In addition, when the absolute value of the steering torque is equal to or higher than the reference torque, the signs of the steering angle, the steering speed, and the steering torque are different from each other, the yaw-rate and the lateral acceleration are respectively equal to or above the reference yaw-rate and the reference lateral acceleration, the processor 170 may determine that the driver has a turning control deactivation intention. In other words, when sensing the turning control intention of the driver, the processor 170 may recognize that the current situation is a situation in which the vehicle enters a turning section. Further, when sensing the turning control deactivation intention of the driver, the processor 170 may recognize that the current situation is a situation in which the vehicle exits the turning section.

In addition, the processor 170 may estimate (calculate) a roll angle and a pitch angle generated in the vehicle based on the driving information. The processor 170 uses the wheel speed, the steering angle, the yaw-rate, and the lateral acceleration included in the driving information to compensate for an error due to a road inclination (a bank angle) and estimate the roll angle. The processor 170 estimates the roll angle based on the lateral acceleration. Because the roll angle estimation may be performed by selectively using a known technology, a detailed description thereof will be omitted.

The processor 170 uses the wheel speed, the steering angle, the yaw-rate, and the longitudinal acceleration to compensate for an error due to a road slope (a slope angle) and estimate the pitch angle. The processor 170 may estimate a pitch angle θ based on the longitudinal acceleration of the vehicle. The pitch angle θ estimated based on the longitudinal acceleration may be represented as in a following [Mathematical equation 1].

θ=p·aₓ [Mathematical equation 1]

In this connection, aₓ is the vehicle longitudinal acceleration, and p is a proportional constant.

The processor 170 may calculate a target pitch angle using an estimated roll angle Φ when the driver has the steering intention. A target pitch angle θ* may be derived as a function proportional to a square of the estimated roll angle Φ, as shown in [Mathematical equation 2].

θ*=k·ϕ² [Mathematical equation 2]

In this connection, k is a proportional constant.

The processor 170 may determine whether to engage in pitch motion control based on a presence or absence of the steering intention of the driver, the wheel speed, and a difference between the target pitch angle and an estimated pitch angle. The processor 170 may determine not to engage in the pitch motion control when there is no driver steering intention.

More specifically, when the target pitch angle is equal to or greater than the estimated pitch angle in the situation in which the driver's turning control intention is sensed, the processor 170 determines to perform pitch angle generation control. In other words, when the current situation is the situation in which the vehicle enters the turning section and the target pitch angle exceeds the estimated pitch angle, the processor 170 determines to engage in the pitch motion control. In one example, when the target pitch angle is equal to or less than the estimated pitch angle in the situation in which the driver's turning control intention is sensed, the processor 170 determines not to engage in the pitch motion control.

In addition, when the target pitch angle is smaller than the estimated pitch angle in the situation in which the driver's turning control deactivation intention is sensed, the processor 170 determines to perform pitch angle suppression control. In other words, when the current situation is the situation in which the vehicle enters the turning section and the target pitch angle is less than the estimated pitch angle, the processor 170 determines to engage in the pitch motion control. In one example, when the target pitch angle is equal to or greater than the estimated pitch angle in the situation in which the driver's turning control deactivation intention is sensed, the processor 170 determines not to engage in the pitch motion control.

When determining to engage in the pitch motion control, the processor 170 calculates a longitudinal acceleration required for the vehicle (required longitudinal acceleration) such that the estimated pitch angle may follow the target pitch angle. The processor 170 may calculate the required longitudinal acceleration (required longitudinal deceleration) for following the target pitch angle based on a vehicle specification, suspension characteristics, and the like.

Next, a process of deriving a required longitudinal acceleration calculation equation will be described.

The processor 170 performs proportional differential (PD) control to reduce the difference between the actual pitch angle (the estimated pitch angle) of the vehicle and the target pitch angle. In other words, the processor 170 controls the difference between the estimated pitch angle and the target pitch angle, that is, a control error ε to converge to ‘0’. In this connection, the control error ε may be represented as in [Mathematical equation 3].

ε=k·ϕ²−p·aₓ→0 [Mathematical equation 3]

A related equation of the PD control for reducing the difference between the estimated pitch angle and the target pitch angle may be represented as [Mathematical equation 4].

Kₚ·ε+K_{d}·=Kₚ(k·ϕ²−p·aₓ)+K_{d}(2k·ϕ·\dot{ϕ}−p·\dot{a}ₓ)=0 [Mathematical equation 4]

In this connection, \dot{ε} is a control error change rate, \dot{ϕ} is a roll angle change rate (a roll rate), Kₚ is a proportional control gain, K_{d} is a change amount control gain, and \dot{a}ₓ is a longitudinal jerk.

[Mathematical equation 4] may be represented as a following [Mathematical equation 5 ] when being arranged for the longitudinal acceleration aₓ by putting [Mathematical equation 3] into [Mathematical equation 4]. In this connection, ax is the required longitudinal acceleration (the required longitudinal deceleration) for generating the target pitch angle.

aₓ=K₁·ϕ·(ϕ+K₂·\dot{ϕ})−K₃·\dot{a}ₓ [Mathematical equation 5]

In this connection, K₁, K₂, and K₃ are PD control equivalent gains.

The processor 170 may calculate a braking force or a traction force of each wheel based on the calculated required longitudinal acceleration. When calculating the braking force or the traction force of each wheel, the processor 170 may consider specifications and responsiveness of the engine and the motor, a specification and responsiveness of a brake, a battery state, and the like.

The processor 170 determines an engine traction force, a motor traction force, a regenerative braking amount, and/or a brake braking pressure for following the braking force or the traction force required for each wheel based on the battery state information. The processor 170 calculates the braking force or the traction force of each wheel based on the determined engine traction force, motor traction force, regenerative braking amount, and/or brake braking pressure.

For example, when braking is required for the electric vehicle and the state of charge is insufficient, the processor 170 may perform control that actively uses regenerative braking and utilizes the brake.

For example, when driving is required for the hybrid electric vehicle and the state of charge is insufficient, the processor 170 may perform control that actively utilizes the engine traction force.

For example, when braking control is required for a long time in the electric vehicle, the processor 170 reduces the braking force of the motor as the braking pressure of the brake increases after starting the braking control by utilizing a responsive motor.

For example, when the braking control is required for a long time in the hybrid electric vehicle, the processor 170 reduces the braking force of the motor as the revolution per minute of the engine decreases after starting the braking control by utilizing the responsive motor.

For example, when acceleration control is required for a long time in the hybrid electric vehicle, the processor 170 reduces the traction force of the driving motor as the revolution per minute of the engine increases after starting the acceleration control by utilizing the responsive motor.

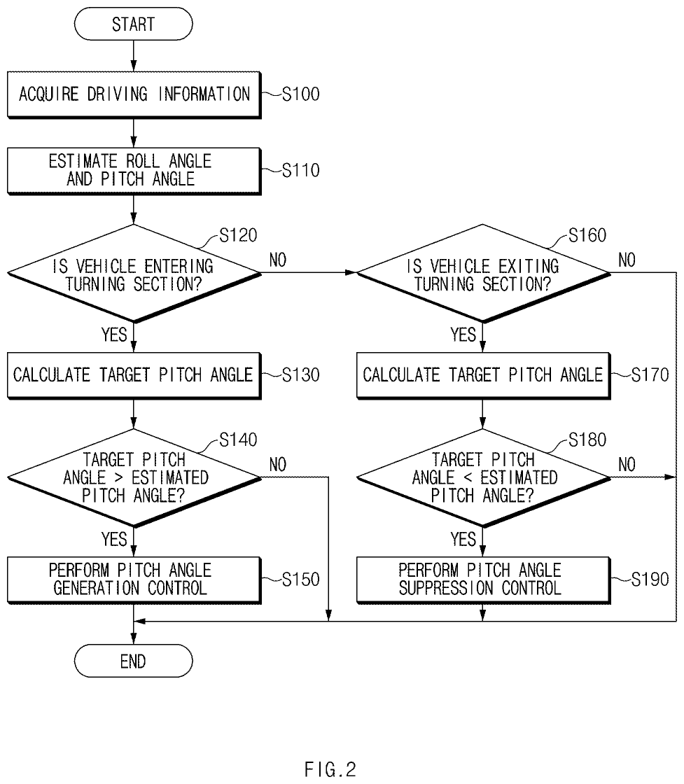

FIG. 2 is a flowchart for illustrating a motion control method of an electrified vehicle according to an embodiment of the present disclosure.

Referring to FIG. 2, the processor 170 acquires the driving information using at least one sensor mounted on the vehicle during the travel (S100). The processor 170 may acquire the driving information such as the wheel speed, the steering torque, the steering angle, the yaw-rate, the lateral acceleration, and/or the longitudinal acceleration of each wheel using the wheel speed sensor 111, the steering torque sensor 112, the steering angle sensor 113, the yaw-rate sensor 114, the lateral acceleration sensor 115 and/or the longitudinal acceleration sensor 116.

The processor 170 estimates the roll angle (the roll motion) and the pitch angle (the pitch motion) generated in the vehicle based on the driving information (S110). The processor 170 compensates for the error due to the road inclination and estimate the roll angle by utilizing the wheel speed, the steering angle, the yaw-rate, and the lateral acceleration. The processor 170 compensates for the error due to the road slope and estimates the pitch angle by utilizing the wheel speed, the steering angle, the yaw-rate, and the longitudinal acceleration.

The processor 170 determines whether the current situation is the situation in which the vehicle enters the turning section based on the driving information (S120). The processor 170 may recognize the steering intention of the driver by utilizing the driving information. When the absolute value of the steering torque is equal to or higher than the reference torque, the signs of the steering angle, the steering speed, and the steering torque are the same, and the yaw-rate and the lateral acceleration are respectively equal to or below the reference yaw-rate and the reference lateral acceleration, the processor 170 may determine that the driver has the turning control intention. When sensing the turning control intention of the driver, the processor 170 may recognize that the current situation is the situation in which the vehicle enters the turning section.

When the current situation is the situation in which the vehicle enters the turning section, the processor 170 calculates the target pitch angle using the estimated roll angle (S130). The processor 170 may calculate the target pitch angle using [Mathematical equation 2].

Subsequently, the processor 170 determines whether the target pitch angle exceeds the estimated pitch angle (S140). The processor 170 determines to engage in the pitch motion control when the target pitch angle exceeds the estimated pitch angle. The processor 170 determines not to engage in the pitch motion control when the target pitch angle is equal to or less than the estimated pitch angle.

When the target pitch angle exceeds the estimated pitch angle, the processor 170 performs the pitch angle generation control (S150). When determining to engage in the pitch motion control, the processor 170 performs control of generating the pitch motion through the braking control. The processor 170 calculates the required longitudinal acceleration required for the vehicle for a following pitch angle, that is, the pitch angle of the vehicle to follow the target pitch angle. The processor 170 adjusts the motor traction force, the engine traction force, the regenerative braking amount (the motor braking force) and/or the brake braking force based on the calculated required longitudinal acceleration.

When the current situation is not the situation in which the vehicle enters the turning section in S120, the processor 170 determines whether the current situation is the situation in which the vehicle exits the turning section (S160). When the absolute value of the steering torque is equal to or higher than the reference torque, the signs of the steering angle, the steering speed, and the steering torque are different from each other, and the yaw-rate and the lateral acceleration are respectively equal to or above the reference yaw-rate and the reference lateral acceleration, the processor 170 may determine that the driver has the turning control deactivation intention. When sensing the turning control deactivation intention of the driver, the processor 170 may recognize that the current situation is the situation in which the vehicle exits the turning section.

When the current situation is the situation in which the vehicle exits the turning section, the processor 170 calculates the target pitch angle using the estimated roll angle (S170).

The processor 170 determines whether the target pitch angle is less than the estimated pitch angle (S180). When the target pitch angle is less than the estimated pitch angle, the processor 170 determines to engage in the pitch motion control.

In one example, when the target pitch angle is equal to or greater than the estimated pitch angle, the processor 170 determines not to engage in the pitch motion control.

When the target pitch angle is less than the estimated pitch angle, the processor 170 performs the pitch angle 23 suppression control (S190). When determining to engage in the pitch motion control, the processor 170 performs control of suppressing the pitch motion through the acceleration control. The processor 170 calculates the required longitudinal acceleration for following the target pitch angle, and adjusts the engine traction force, the motor traction force, the regenerative braking amount, and/or the brake braking force based on the calculated required longitudinal acceleration.

As described above, the processor 170 may determine whether to engage in the pitch motion control based on the presence or absence of the steering intention of the driver and the difference between the target pitch angle and the estimated pitch angle. When there is the steering intention of the driver and the difference between the target pitch angle and the estimated pitch angle is out of an allowable error range, the processor 170 may determine to engage in the pitch motion control. When there is no steering intention of the driver or the difference between the target pitch angle and the estimated pitch angle is within the allowable error range, the processor 170 may determine not to engage in the pitch motion control. When determining to engage in the pitch motion control, the processor 170 calculates the longitudinal acceleration required for the actual pitch angle of the vehicle to follow the target pitch angle, and controls the pitch motion by adjusting the engine, the motor, a regenerative brake, the brake, and the like based on the calculated required longitudinal acceleration.

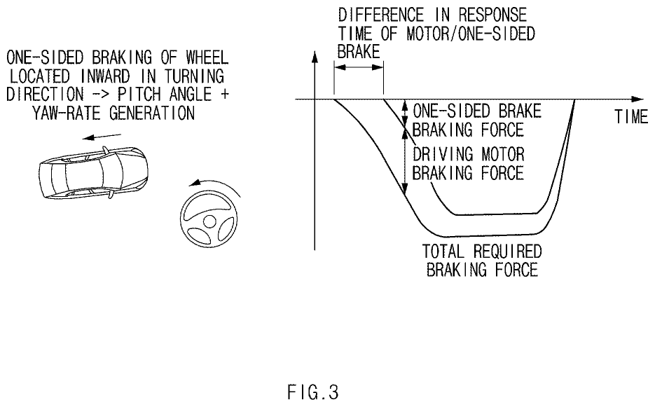

FIG. 3 is a view for illustrating motion control of an electrified vehicle according to another embodiment of the present disclosure. In the present embodiment, pitch motion control of the vehicle using a one-sided brake will be described.

When deceleration is required to generate the pitch angle, the motion control device 100 of the electrified vehicle may calculate a total required braking force required for the pitch angle generation. The motion control device 100 may adjust the braking force by controlling the motor and a one-sided brake based on the calculated total required braking force. In this connection, the motion control device 100 may reduce the braking force of the motor when a braking force of the one-sided brake increases after starting the braking control using a motor having a response speed higher than that of the one-sided brake first. The motion control device 100 performs one-sided braking on a wheel located inward in a turning direction through the one-sided brake to allow the pitch angle and the yaw-rate to be generated simultaneously.

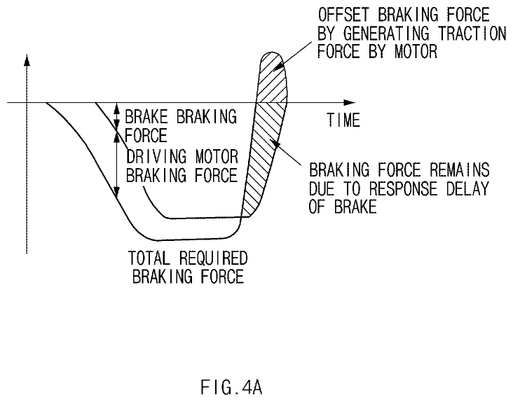

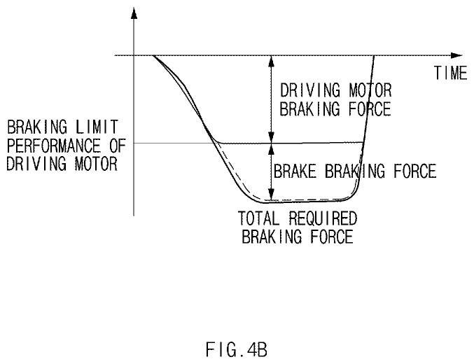

FIGS. 4A and 4B are views for illustrating motion control of an electrified vehicle according to another embodiment of the present disclosure.

Referring to FIG. 4A, when deactivating the braking control of the vehicle, the braking force remains after deactivating the braking control because of a brake having a response speed lower than that of the motor. In this connection, the motion control device 100 may perform control of offsetting the unnecessary braking force by controlling the driving of the motor.

Referring to FIG. 4B, when controlling the braking of the vehicle, and when the required braking force exceeds a braking limit performance of the driving motor, the motion control device 100 generates a braking force that exceeds the braking limit performance of the driving motor using the brake. In other words, when a maximum braking force that may be generated by the driving motor and the regenerative brake is less than the required braking force, the motion control device 100 may preferentially perform braking through the driving motor and the regenerative brake, but may control an insufficient braking force through brake braking.

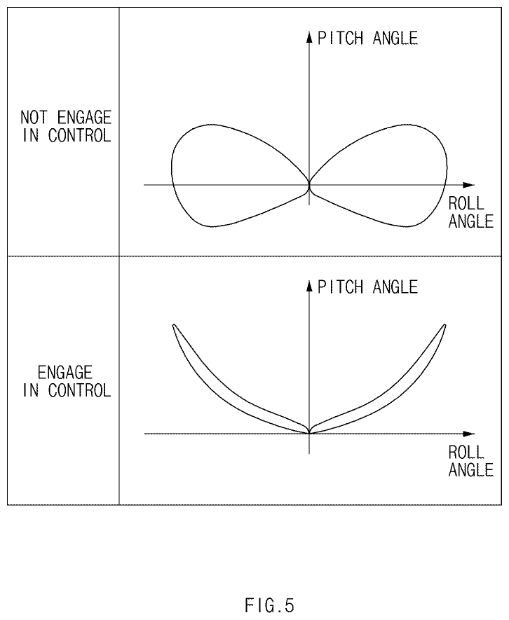

FIG. 5 is roll angle-pitch angle graphs with or without pitch motion control according to an embodiment of the present disclosure.

Referring to FIG. 5, when the pitch motion control is not performed during the vehicle turning, the driver may feel that handling is bad. On the other hand, according to the pitch motion control technology presented in the present disclosure, not only the roll motion but also the pitch motion are controlled based on the traction force or the braking force when the vehicle turns, so that the driver may feel that the handling is good.

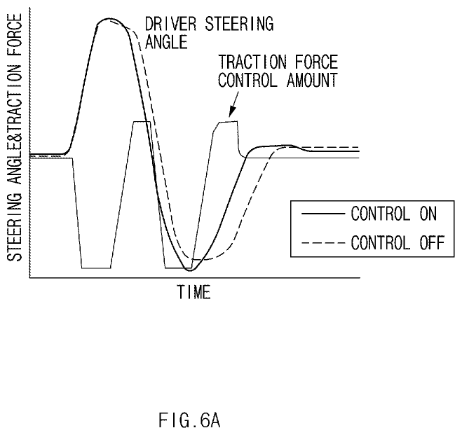

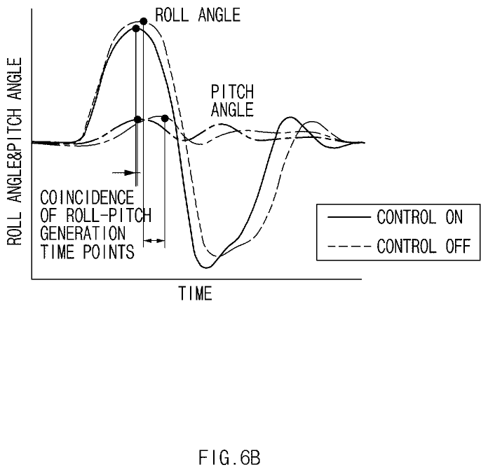

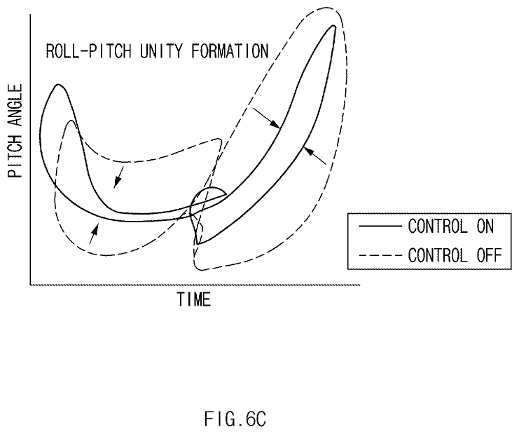

FIGS. 6A to 6C are views for illustrating a change in a vehicle motion based on pitch motion control according to an embodiment of the present disclosure.

Referring to FIG. 6A, when controlling the motion, the traction force may be rapidly reproduced in response to steering angle control of the driver, so that a handling performance may be improved.

Referring to FIG. 6B, when the vehicle enters the turning section, a delay time from roll angle generation to pitch angle generation may be reduced through the pitch angle generation control (the braking control) to coincide the generation times of the roll angle and the pitch angle with each other. In addition, when the vehicle exits the turning section, roll angle reduction and pitch angle reduction may be controlled to be performed at the same time through the pitch angle suppression control (the acceleration control). Thus, as shown in FIG. 6C, roll-pitch unity may be improved when controlling the motion.

Referring to FIG. 6C, in the pitch motion control process, vertical forces of a front wheel and a rear wheel are controlled, so that the roll angle decreases and a moment required for the turning increases, thereby improving a turning responsiveness.

The description above is merely illustrative of the technical idea of the present disclosure, and various modifications and changes may be made by those skilled in the art without departing from the essential characteristics of the present disclosure. Therefore, the embodiments disclosed in the present disclosure are not intended to limit the technical idea of the present disclosure but to illustrate the present disclosure, and the scope of the technical idea of the present disclosure is not limited by the embodiments. The scope of the present disclosure should be construed as being covered by the scope of the appended claims, and all technical ideas falling within the scope of the claims should be construed as being included in the scope of the present disclosure.

According to the present disclosure, the difference between the generation time points of the roll angle and the pitch angle generated in the vehicle may be reduced by adjusting the pitch angle of the vehicle when the driver steers, so that a sense of unity between the vehicle and the driver may be provided when the vehicle turns.

Hereinabove, although the present disclosure has been described with reference to exemplary embodiments and the accompanying drawings, the present disclosure is not limited thereto, but may be variously modified and altered by those skilled in the art to which the present disclosure pertains without departing from the spirit and scope of the present disclosure claimed in the following claims.

What is claimed is:

1. A device for controlling a motion of an electrified vehicle, the device comprising:
a detector for detecting driving information of the vehicle; and
a processor configured to:
estimate a roll angle and a pitch angle of the vehicle based on the driving information;
determine whether the vehicle enters or exits a turning section based on the driving information;
calculate a target pitch angle based on the estimated roll angle when the vehicle enters or exits the turning section;
compare the target pitch angle with the estimated pitch angle; and
control a pitch motion of the vehicle based on the comparison result.

2. The device of claim 1, wherein the detector includes at least one of a wheel speed sensor, a steering torque sensor, a steering angle sensor, a yaw-rate sensor, a lateral acceleration sensor, or a longitudinal acceleration sensor.

3. The device of claim 1, wherein the processor is configured to compensate for an error caused by a road inclination and estimate the roll angle based on a wheel speed, a steering angle, a yaw-rate, and a lateral acceleration of the driving information.

4. The device of claim 1, wherein the processor is configured to compensate for an error caused by a road slope and estimate the pitch angle based on utilizing a wheel speed, a steering angle, a yaw-rate, and a longitudinal acceleration of the driving information.

5. The device of claim 1, wherein the processor is configured to recognize a steering intention of a driver based on a steering torque, a steering angle, a steering speed, a yaw-rate, and a lateral acceleration of the driving information.

6. The device of claim 5, wherein the processor is configured to determine that the vehicle enters the turning section, when an absolute value of the steering torque is equal to or higher than a reference torque, signs of the steering angle, the steering speed, and the steering torque are the same, and the yaw-rate and the lateral acceleration are respectively equal to or below a reference yaw-rate and a reference lateral acceleration.

7. The device of claim 5, wherein the processor is configured to determine that the vehicle exits the turning section, when an absolute value of the steering torque is equal to or higher than a reference torque, signs of the steering angle, the steering speed, and the steering torque are different from each other, the yaw-rate and the lateral acceleration are respectively equal to or above a reference yaw-rate and a reference lateral acceleration.

8. The device of claim 1, wherein the processor is configured to perform pitch angle generation control when the target pitch angle exceeds the estimated pitch angle when the vehicle enters the turning section.

9. The device of claim 8, wherein the processor is configured to perform pitch angle suppression control when the target pitch angle is less than the estimated pitch angle when the vehicle exits the turning section.

10. The device of claim 1, wherein the processor is configured to control the pitch angle and a yaw-rate simultaneously using a one-sided braking force when controlling the pitch motion of the vehicle is performed through deceleration control.

11. A method for controlling a motion of an electrified vehicle, the method comprising:
detecting driving information of the vehicle;
estimating a roll angle and a pitch angle of the vehicle based on the driving information;
determining whether the vehicle enters or exits a turning section based on the driving information;
calculating a target pitch angle using the estimated roll angle when the vehicle enters or exits the turning section;
comparing the target pitch angle with the estimated pitch angle; and
controlling a pitch motion of the vehicle based on the comparison result.

12. The method of claim 11, wherein the estimating of the roll angle and the pitch angle of the vehicle includes:
compensating for an error caused by a road inclination and estimating the roll angle based on a wheel speed, a steering angle, a yaw-rate, and a lateral acceleration of the driving information; and
compensating for an error caused by a road slope and estimating the pitch angle based on the wheel speed, the steering angle, the yaw-rate, and a longitudinal acceleration of the driving information.

13. The method of claim 11, wherein the determining of whether the vehicle enters or exits the turning section further includes:
recognizing a steering intention of a driver using a steering torque, a steering angle, a steering speed, a yaw-rate, and a lateral acceleration of the driving information.

14. The method of claim 13, wherein the determining of whether the vehicle enters or exits the turning section includes:
determining that the vehicle enters the turning section, when an absolute value of the steering torque is equal to or higher than a reference torque, signs of the steering angle, the steering speed, and the steering torque are the same, and the yaw-rate and the lateral acceleration are respectively equal to or below a reference yaw-rate and a reference lateral acceleration; and
determining that the vehicle exits the turning section, when the absolute value of the steering torque is equal to or higher than the reference torque, the signs of the steering angle, the steering speed, and the steering torque are different from each other, the yaw-rate and the lateral acceleration are respectively equal to or above the reference yaw-rate and the reference lateral acceleration.

15. The method of claim 11, wherein the calculating of the target pitch angle includes:
calculating the target pitch angle minimizing a difference between generation time points of the roll angle and the pitch angle.

16. The method of claim 11, wherein the controlling of the pitch motion includes:
performing pitch angle generation control when the target pitch angle exceeds the estimated pitch angle when the vehicle enters the turning section.

17. The method of claim 11, wherein the controlling of the pitch motion includes:
performing pitch angle suppression control when the target pitch angle is less than the estimated pitch angle when the vehicle exits the turning section.

18. The method of claim 11, wherein the controlling of the pitch motion includes:
calculating a longitudinal acceleration required for the vehicle for an actual pitch angle of the vehicle to follow the target pitch angle; and
controlling acceleration or braking of the vehicle based on the calculated longitudinal acceleration.

19. The method of claim 11, wherein the controlling of the pitch motion includes:
controlling the pitch angle and a yaw-rate simultaneously using a one-sided braking force when controlling the pitch motion of the vehicle is performed through deceleration control.

20. The method of claim 11, wherein the controlling of the pitch motion further includes:
generating a motor traction force to offset a braking force remaining due to a response delay of a brake when deactivating braking control.
